(19) United States
(12) Patent Application Publication
(10) Pub. No.: US 2026/0072394 A1
(43) Pub. Date: Mar. 12, 2026

(54) IMAGE FORMING APPARATUS

(71) Applicant: CANON KABUSHIKI KAISHA, Tokyo (JP)

(72) Inventors: YASUHIKO FUSE, Shizuoka (JP); TSUKASA ABE, Kanagawa (JP)

(21) Appl. No.: 19/316,679

(22) Filed: Sep. 2, 2025

(30) Foreign Application Priority Data
Sep. 12, 2024 (JP) 2024-158651

(51) Int. Cl. G03G 21/16; B41J 2/44; B41J 2/47; G03G 15/00; G03G 15/01; G03G 15/04; G03G 15/041

(52) U.S. Cl. CPC G03G 21/1647; B41J 2/442; B41J 2/47; G03G 15/011; G03G 15/0189; G03G 15/04036; G03G 15/0415; G03G 15/80; G03G 21/1633; G03G 2221/1654

(57) ABSTRACT

An image forming apparatus includes a scanner unit, a laser shutter including a first engaging portion and to shield a laser light from the scanner unit, an opening/closing member to a main assembly, a link operable in interrelation with the opening/closing member and an interlock switch including a second engaging portion and to turn on or turn off a high voltage power source. The link includes a third engaging portion engaged with the first engaging portion of the laser shutter and a fourth engaging portion engaged with the second engaging portion of the interlock switch. The first engaging portion of the laser shutter is disposed on one side surface of a casing of the scanner unit. The second engaging portion of the interlock switch is disposed at a position opposing the one side surface.

### BACKGROUND

### Field of the Technology

The present invention relates to an image forming apparatus for forming an image on a recording material.

### Description of the Related Art

The image forming apparatus such as a printer, a copier, and a multifunction printer is provided with an opening/closing cover (opening/closing member) which is capable of opening and closing with respect to a main assembly of the apparatus for supplying a toner, processing paper jam (hereinafter referred to as a jam processing), etc. The image forming apparatus is configured so that when the opening/closing cover is opened, a laser light is not irradiated from a light source to an outside of the apparatus and a high voltage power source is turned off. Therefore, the image forming apparatus is provided with an interlock switch and a link mechanism for turning on and off a laser shutter member and the high voltage power source. In Japanese Laid-Open Patent Application (JP-A) Hei 08-297435, the opening/closing cover which is provided with an engaging portion for turning on an operation of a laser shutter and the interlock switch is disclosed. A protrusion shape for operating a laser shutter and a protrusion shape for turning on an interlock switch are provided with the opening/closing cover, and the laser shutter and the interlock switch are directly operated by the opening/closing operation of the opening/closing cover. Further, in Japanese Laid-Open Patent Application (JP-A) Hei 03-131871, a configuration is disclosed in which the interlock switch is disposed in a swingable switch holder, and the laser shutter is also actuated by the switch holder.

However, there are following issues related to conventional image forming apparatuses. For example, in a configuration which is provided with the protrusion shapes, the protrusion shapes which are provided with the opening/closing cover are divided into one for the laser shutter and the other for the interlock switch. Therefore, when the opening/closing cover is unintentionally twisted by a manipulation, a time difference may be occurred between the operation of the laser shutter and an on timing of the interlock switch. For example, in a case that an order of operations is needed such as opening the laser shutter after the interlock switch is turned on, it is necessary to increase a torsional rigidity of the opening/closing cover so that the difference is not occurred between the operation of the laser shutter and the on timing of the interlock switch. Further, in the configuration which applies the switch holder, the configuration is that the interlock switch is turned on when the protrusion shapes of the opening/closing cover and an upper unit which accommodates the toner are aligned. Due to such a configuration, it is necessary to simplify these mechanisms as much as possible in order to turn on and off the interlock switch with high accuracy. In order to do that, it is necessary to place the interlock switch near an outer cover of the product and near the opening/closing cover naturally, and a restriction of a position on which the switch is placed may be occurred.

### SUMMARY

In response to the above issue, it is an object of the present invention to operate the laser shutter and the interlock switch regardless of the torsion of the opening/closing cover, and to increase a degree of freedom of a placing position of the interlock switch without requiring a complicated mechanism.

In order to solve the above issue, the present invention is provided with a configuration described below. An image forming apparatus for forming an image on a recording material, the image forming apparatus comprising: a scanner unit configured to emit a laser light depending on an image signal; a photosensitive member on which a latent image is formed by the laser light emitted from the scanner unit; a laser shutter including a first engaging portion and configured to shield the laser light; an opening/closing member openable and closable to a main assembly of the image forming apparatus; a link configured to operate in interrelation with an opening/closing operation of the opening/closing member; and an interlock switch including a second engaging portion and configured to turn on or turn off a high voltage power source, wherein the link includes a third engaging portion engaged with the first engaging portion of the laser shutter and a fourth engaging portion engaged with the second engaging portion of the interlock switch, wherein the first engaging portion of the laser shutter is disposed on one side surface of a casing of the scanner unit, and wherein the second engaging portion of the interlock switch is disposed at a position opposing the one side surface of the casing of the scanner unit.

Further features of the present disclosure will become apparent from the following description of exemplary embodiments with reference to the attached drawings.

### BRIEF DESCRIPTION OF THE DRAWINGS

FIG. 1 is a view illustrating an overall configuration of a printer according to a first embodiment.

FIG. 2 is a view showing the printer while a door is opened according to the first embodiment.

FIG. 3 is a view illustrating a laser shutter according to the first embodiment.

FIG. 4 is a bottom view showing the laser shutter and a scanner according to the first embodiment.

FIG. 5 is a sectional view illustrating the laser shutter and the scanner according to the first embodiment.

Part (a) of FIG. 6 is a view illustrating the laser shutter according to the first embodiment in a case of blocking a laser, and part (b) of FIG. 6 is a view illustrating the laser shutter according to the first embodiment in a case of transmitting the laser.

Part (a), part (b), part (c), part (d), part (e), and part (f) of FIG. 7 are views showing an opening/closing of a door and an operation of the laser shutter according to the first embodiment.

Part (a) of FIG. 8 is a perspective view showing mounting of an interlock switch and part (b) of FIG. 8 is a front view showing mounting of the interlock switch according to the first embodiment.

Part (a), part (b), part (c), part (d), part (e), and part (f) of FIG. 9 are views showing the opening/closing of the door and an on/off of the interlock switch according to the first embodiment.

Part (a) of FIG. 10 is a view showing a positional relationship of the laser shutter and the interlock switch, and part (b) of FIG. 10 is a view illustrating a mounting position of the interlock switch according to the first embodiment.

FIG. 11 is a view illustrating a locus of the opening/closing of the door and a moving direction of a link according to the first embodiment.

FIG. 12 is a view illustrating a mounting position of the interlock switch according to a second embodiment.

### DESCRIPTION OF THE EMBODIMENTS

In the following, an image forming apparatus according to embodiments will be specifically described with reference to the drawings. However, dimensions, materials, shapes, relative placements, etc. of component parts which are described in the embodiments may be changed as appropriate depending on configurations of devices to which the present invention is applied and various conditions. That is, a scope of the present invention is not intended to be limited to the embodiments which are described below.

### First Embodiment

### Overall Configuration

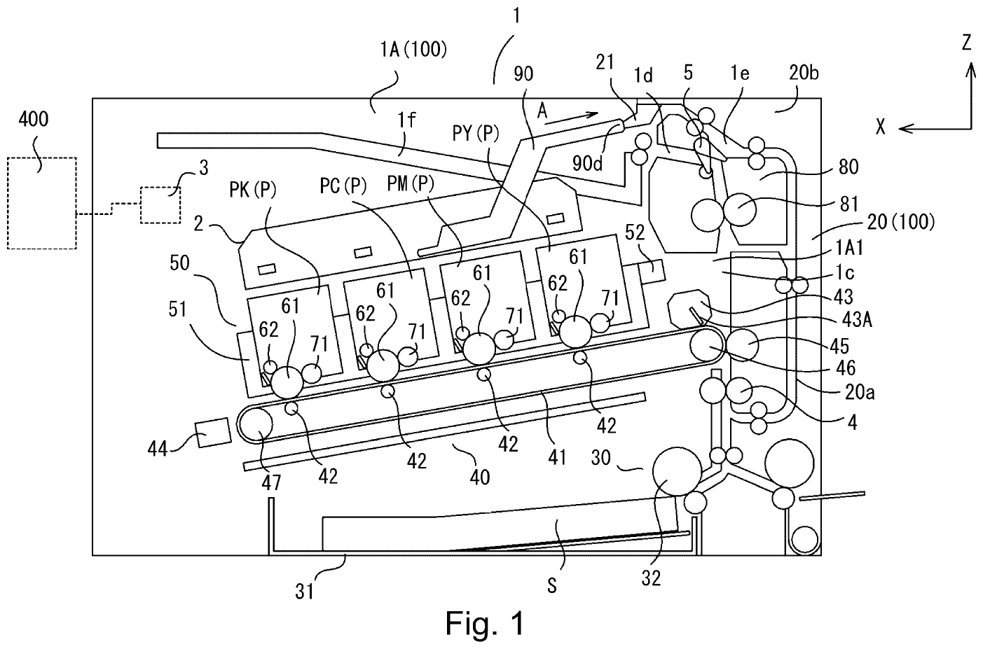

With reference to FIG. 1, a printer 1 as an image forming apparatus will be described. FIG. 1 is a view illustrating an overall configuration of the printer 1 according to a first embodiment. The printer 1 is a color laser beam printer using an electrophotographic method which forms an image on a sheet S as a recording material (on a recording material). The printer 1 includes a main assembly (casing) 1A, a scanner unit (exposure device) 2, a control portion 3, and a door 20 as an opening/closing member which is capable of opening and closing with respect to the main assembly 1A. The printer 1 includes a sheet feeding portion 30, a transfer unit 40, a tray unit (tray unit, moving unit, supporting unit) 50, and a fixing device 80. A portion which includes the main assembly 1A and the door 20 may also be defined as a main frame 100. The main frame 100 includes an exterior portion of the printer 1. The main assembly 1A accommodates a scanner unit 2, the control portion 3, the sheet feeding portion 30, the transfer unit 40, the tray unit 50, and the fixing device 80. The sheet feeding portion 30 includes a stacking tray 31 which stacks the sheet S and a supplying roller 32. The stacking tray 31 is capable of replenishing the sheet S by pulling out in a direction toward the door 20.

The tray unit 50 includes a tray (supporting member, drawer) 51 and cartridges PY, PM, PC, and PK. The tray 51 includes a tray handle 52. The cartridges PY, PM, PC, and PK are removably mounted on the tray 51. Each of the cartridges PY, PM, PC, and PK is independently dismountable from the tray 51. The cartridges PY, PM, PC, and PK accommodate the toners (developers) of yellow (Y), magenta (M), cyan (C), and black (K), respectively. Configurations of the cartridges PY, PM, PC, and PK are same except for the colors of the toners which are accommodated. Therefore, a configuration and an operation of one of the cartridges PY, PM, PC, and PK may be described, and descriptions of the others may be omitted. Further, in a case that it is not necessary to distinguish between the cartridges PY, PM, PC, and PK, the cartridges PY, PM, PC, and PK may be referred to simply as a cartridge P. The tray unit 50 may include the plurality of cartridges P and the tray 51 on which the plurality of cartridges P are removably mounted.

In the first embodiment, the tray unit 50 includes a plurality of photosensitive drums (image bearing members, photosensitive members) 61, a plurality of charging rollers 62 (charging members), and a plurality of developing rollers (developer carrying members, developing members) 71. Specifically, the tray unit 50 includes four photosensitive drums 61, four charging rollers 62, and four developing rollers 71. A direction of a rotational axis of the photosensitive drum 61, a direction of a rotational axis of the developing roller 71, and a direction of a rotational axis of the charging roller 62 are parallel. A portion which forms an image of the black (K) is defined as a black station (a first station), the photosensitive drum 61 of the first station is defined as a first photosensitive drum, the developing roller 71 of the first station is defined as a first developing roller, and the charging roller 62 of the first station is defined as a first charging roller. A portion which forms an image of the cyan (C) is defined as a cyan station (a second station), the photosensitive drum 61 of the second station is defined as a second photosensitive drum, the developing roller 71 of the second station is defined as a second developing roller, and the charging roller 62 of the second station is defined as a second charging roller. A portion which forms an image of the magenta (M) is defined as a magenta station (a third station), the photosensitive drum 61 of the third station is defined as a third photosensitive drum, the developing roller 71 of the third station is defined as a third developing roller, and the charging roller 62 of the third station is defined as a third charging roller. A portion which forms an image of the yellow (Y) is defined as a yellow station (a fourth station), the photosensitive drum 61 of the fourth station is defined as a fourth photosensitive drum, the developing roller 71 of the fourth station is defined as a fourth developing roller, and the charging roller 62 of the fourth station is defined as a fourth charging roller.

A cartridge PK is mounted on the black station, a cartridge PC is mounted on the cyan station, a cartridge PM is mounted on the magenta station, and a cartridge PY is mounted on the yellow station. In the first embodiment, the cartridge PK is defined as a first cartridge, the cartridge PC is defined as a second cartridge, the cartridge PM is defined as a third cartridge, and the cartridge PY is defined as a fourth cartridge. Incidentally, numbers such as first, second, third, and fourth are used for convenience of explanation. The photosensitive drum 61, the charging roller 62, and the developing roller 71 may be provided with either the cartridge P or the tray 51. In the first embodiment, the cartridge P includes the photosensitive drum 61, the charging roller 62, and the developing roller 71.

The transfer unit 40 includes a belt 41, a primary transfer roller 42, a cleaning portion 43, a driving roller 46 which drives the belt 41, and a tension roller (driven roller) 47. An optical sensor 44 which detects a toner image (developer image) which is transferred to the belt 41 is disposed on the printer 1. The belt 41 is disposed below the photosensitive drum 61 and is possible to contact the photosensitive drum 61 so that a primary transfer portion is formed between the belt 41 and the photosensitive drum 61. Further, the printer 1 includes a secondary transfer roller 45 (transfer member) which contacts the belt 41 so that a secondary transfer portion is formed. The secondary transfer portion is formed between the belt 41 and the secondary transfer roller 45. A direction of a rotational axis of the primary transfer roller 42, a direction of a rotational axis of the driving roller 46, a direction of a rotational axis of the tension roller 47, and a direction of a rotational axis of the secondary transfer roller 45 are parallel. A registration roller pair 4 is disposed in front of the secondary transfer portion. The fixing device 80 includes a fixing portion 81 and a flapper 5. The fixing unit 81 includes a heating portion (heating roller) including a heater and a pressing portion (pressing roller).

### Image Forming Operation

An image forming operation of the printer 1 will be described with reference to FIG. 1. The control portion 3 of the printer 1 starts the image forming operation on the sheet S based on an image signal which is received from an external host device 400. The external host device 400 is, for example, a personal computer, an image reader, a fax machine, etc.

When image forming on the sheet S is performed, a charging voltage is applied to the charging roller 62, and the photosensitive drum 61 rotates. A laser light which corresponds to an image information is irradiated from the scanner unit 2 to the photosensitive drum 61, and a surface of the photosensitive drum 61, which is charged by the charging roller 62, is exposed. In this way, an electrostatic latent image which corresponds to the image information is formed on the surface of the photosensitive drum 61.

The developing roller 71 carries the toner. A developing voltage is applied to the developing roller 71, and the electrostatic latent image which is formed on the photosensitive drum 61 is developed by the toner which is supplied from the developing roller 71, and the toner image is formed on the surface of the photosensitive drum 61. In the first embodiment, the developing roller 71 develops the electrostatic latent image while it is contacting the photosensitive drum 61, however, the developing roller 71 may develop the electrostatic latent image while there is a gap between the developing roller 71 and the photosensitive drum 61.

When a full color image is formed, a toner image of each color is formed on each photosensitive drum 61. The toner image which is formed on each photosensitive drum 61 is transferred onto the belt 41 by the primary transfer roller 42 in the primary transfer portion so as to be superimposed, and is conveyed toward the second transfer portion which is formed by the belt 41 and the secondary transfer roller 45.

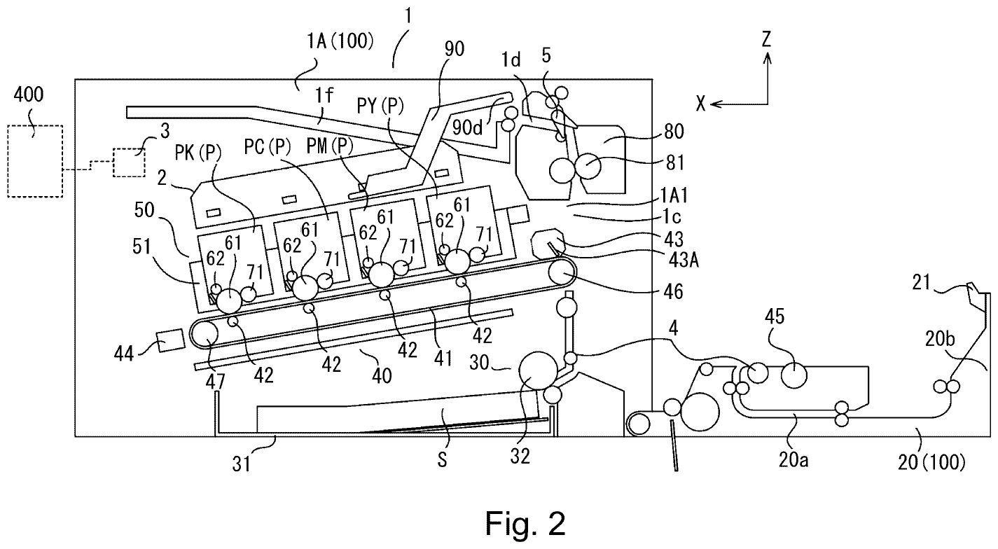

On the other hand, a conveying passage (first passage, first conveying passage) 1c, through which the sheet S which moves toward the fixing device 80 passes, is formed in the main assembly 1A. Further, a double-sided conveying passage (second passage, second conveying passage) 20a through which the sheet S which has passed through the fixing device 80 passes is formed in the door 20. The door 20 covers the conveying passage 1c while it is closed. When the door 20 is opened, the conveying passage 1c and the double-sided conveying passage 20a are exposed (see FIG. 2).

In the sheet feeding portion 30, among the plurality of sheets S which are stacked on the stacking tray 31, one of the sheets S is separated and fed by the supplying roller 32 at a predetermined timing, and conveyed through the conveying passage 1c toward the secondary transfer portion and the fixing device 80. In the secondary transfer portion, the toner image is transferred from the belt 41 to the sheet S. The toner which is not transferred to the sheet S is removed from the belt 41 by a cleaning blade (cleaning member) 43A which is provided in the cleaning portion 43.

The sheet S, on which the toner image is transferred in the secondary transfer portion, is conveyed toward the fixing device 80. In the fixing device 80, the sheet S is heated and pressed at the fixing portion 81, and the unfixed toner image is fixed to the sheet S. The sheet S on which the toner image is fixed is conveyed toward the flapper 5 as a passage switching portion. The flapper 5 is movable between a discharging position in which the sheet S which has passed through the fixing device 80 is guided toward a discharging passage 1d and a reversing position in which the sheet S is guided toward a reversing passage 1e. In a case that single-sided printing is performed in which an image is formed on one side of the sheet S, the sheet S is guided to the discharging passage 1d by the flapper 5 and discharged to a discharging tray 1f which is formed at an upper portion of the main assembly 1A.

On the other hand, in a case that double-sided printing is performed in which the image is printed on one side and a back side of the sheet S, the sheet S is guided to the reversing passage 1e by the flapper 5. After the sheet S is guided to the reversing passage 1e, a conveying direction of the sheet S is reversed, and the sheet S is conveyed toward the secondary transfer portion through the double-sided conveying passage 20a which is formed in the door 20. After the toner image is transferred to the back side of the sheet S in the secondary transfer portion, the sheet S passes through the fixing device 80, is guided to the discharging passage 1d by the flapper 5, and is discharged to the discharging tray 1f of the main assembly 1A.

### Opening/Closing of Door and Link Operation

An opening/closing operation of the door 20 and a link 90 will be described with reference to FIG. 1 and FIG. 2. The door 20 which is mounted on the main assembly 1A is movable between a closing position and an opening position. The main assembly 1A is provided with an opening 1A1 for inserting and removing the transfer unit 40 and the tray unit 50 and for jam processing. As shown in FIG. 1, the door 20 covers the opening 1A1, while the door 20 is in the closing position (closing state of the door 20). As shown in FIG. 2, the opening 1A1 is exposed, while the door 20 is in the opening position (opening state of the door 20).

As shown in FIG. 1, the door 20 covers the fixing device 80 which is mounted on the main assembly 1A, while the door 20 is in the closing position. More specifically, a top cover portion 20b of the door 20 is positioned above the fixing device 80, while the door 20 is in the closing position. The top cover portion 20b of the door 20 functions as a part of the exterior portion.

The door 20 is capable of moving to the opening position and the closing position while the fixing device 80 is supported by the main assembly 1A. In other words, the door 20 moves from the closing position to the opening position so as to move away from the fixing device 80 which is supported by the main assembly 1A. Therefore, as shown in FIG. 2, while the door 20 is in the opening position, the door 20 is separated from the fixing device 80 which is supported by the main assembly 1A. When the door is in the opening position, it is possible to perform replacing the cartridges, jam processing (paper jam processing), etc. In the first embodiment, one door is provided with the main assembly 1A and various manipulations are possible to perform by opening/closing operations of the door 20 which is one, so it is easy to understand for a user and suitable.

The link 90 which is linked with the opening/closing of the door 20 is provided with the main assembly 1A. The link 90 is disposed so as to be slidable between a standby position and a working position in accordance with the opening/closing of the door 20, and is configured to engage with the door 20 at one end portion of the link 90. A protrusion member 21 (protrusion portion) for engaging with the link 90 is provided with the door 20, and the protrusion member 21 is integrally mounted on the door 20. In the first embodiment, the protrusion member 21 is separate from the door 20, however, it may be formed integrally as the door 20 itself. In this way, when one end portion of the link 90 is referred to as an engaging portion 90d, the protrusion member 21 of the door 20 engages with the engaging portion 90d while the door 20 is in the closing position.

In FIG. 1, the door 20 is in the closing position, and at this time, the link 90 is in a state of the working position. When the door 20 is moved toward the opening position from the state, the protrusion member 21 of the door 20 moves away from the engaging portion 90d of the link 90, that is, the engagement is released. In this way, the link 90 moves in a direction of an arrow A in FIG. 1 by means of an unshown elastic member. In FIG. 2, the link 90 is in the standby position. The operation of the laser shutter and the interlock switch which is caused by the movement of the link 90 is will be more specifically described below.

### Laser Shutter Operation

The scanner unit 2 is provided with a laser shutter 2S. The laser shutter 2S is a member which prevents the laser light from leaking to an outside of the main assembly 1A, and is configured so that the laser shutter 2S closes while the door 20 is open. Therefore, for example, even in a case that the laser light is irradiated from the scanner unit 2 while an electrical board which drives the light source which irradiates the laser light is malfunctioning and the door 20 is open, the laser shutter 2S blocks the laser light, so the laser light is prevented from leaking to the outside of the main assembly 1A.

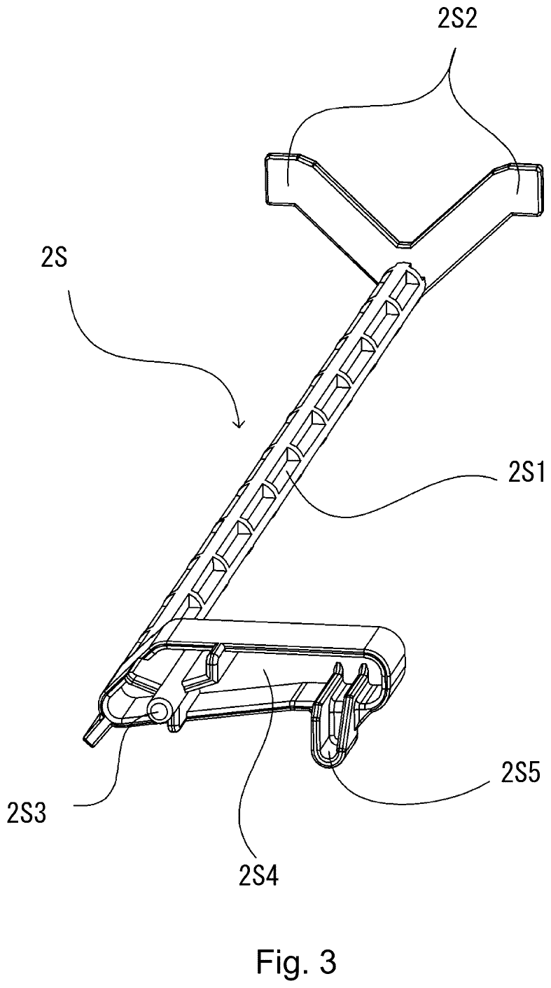

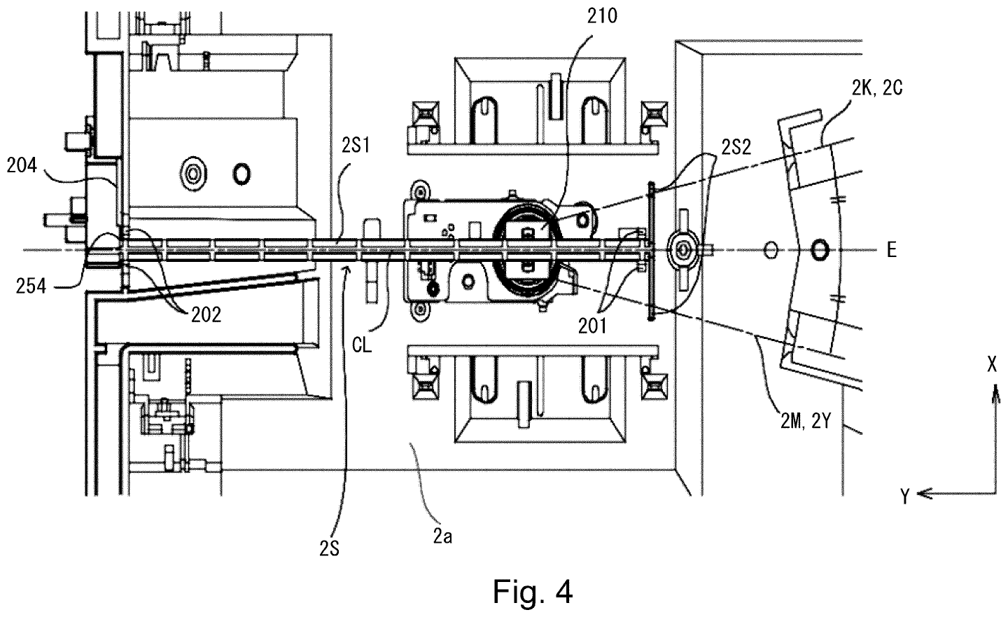

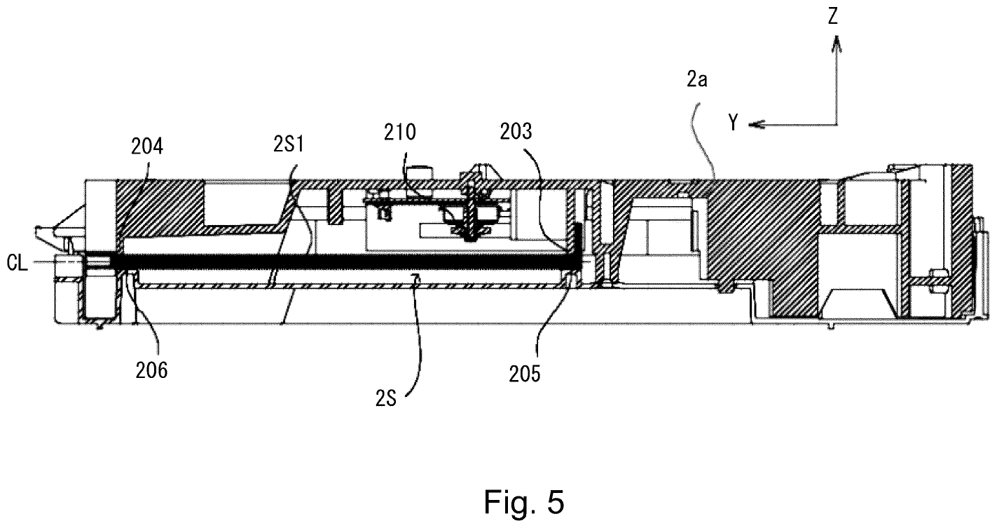

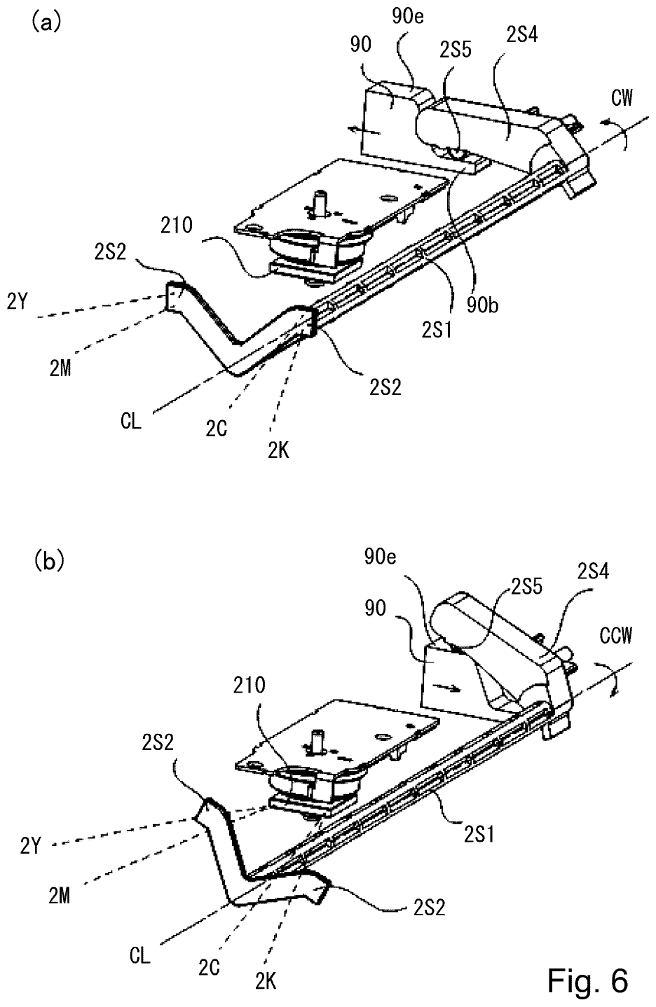

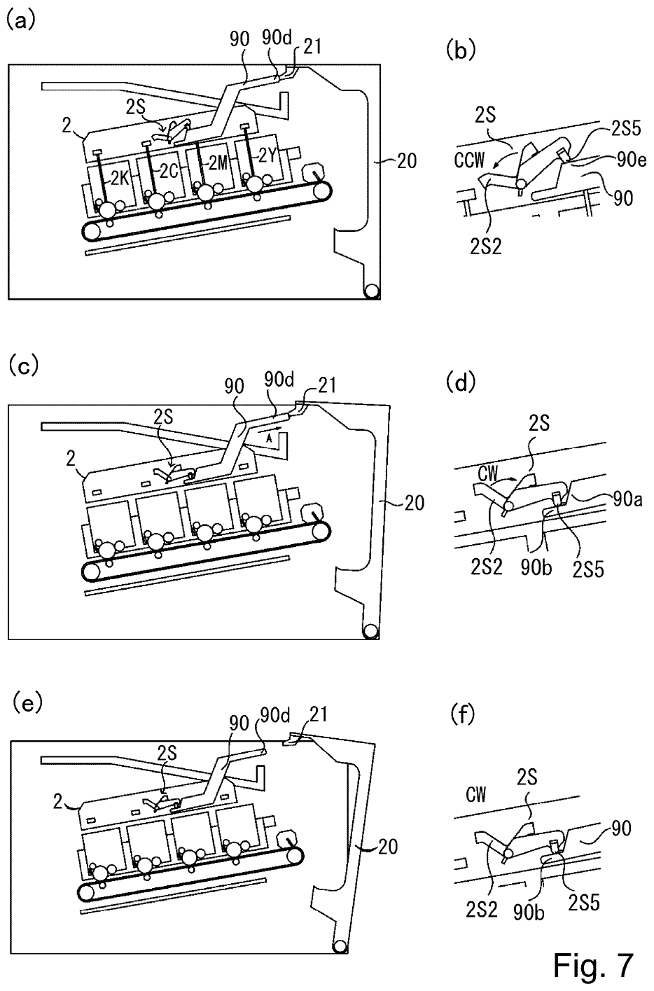

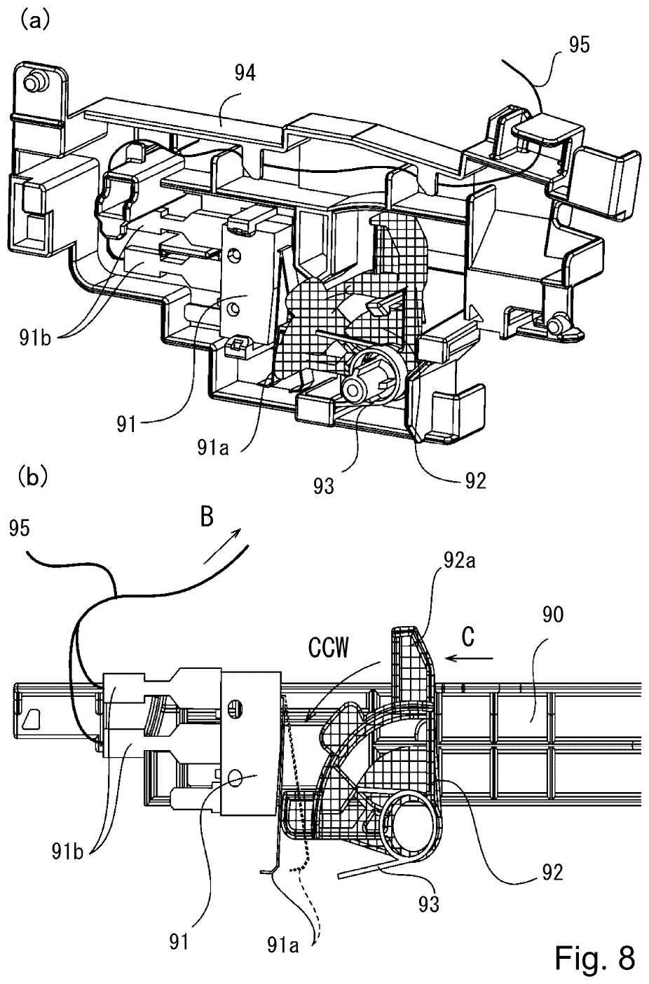

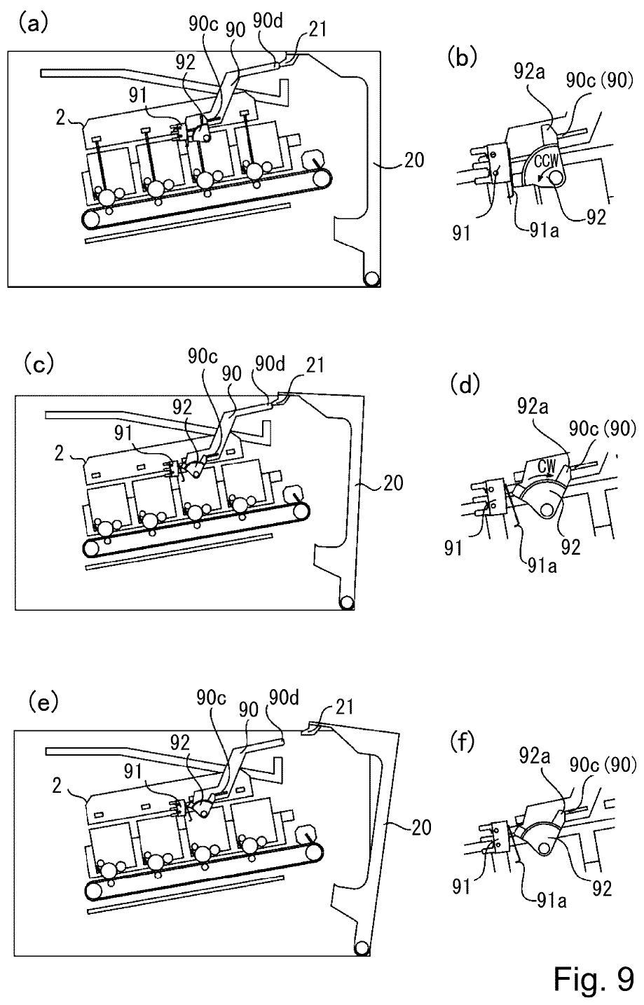

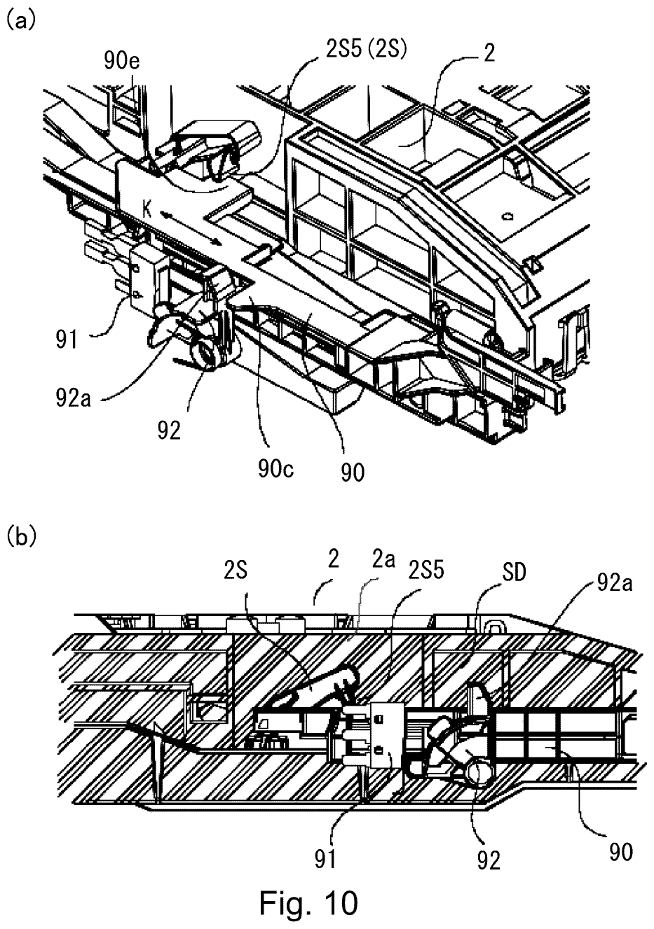

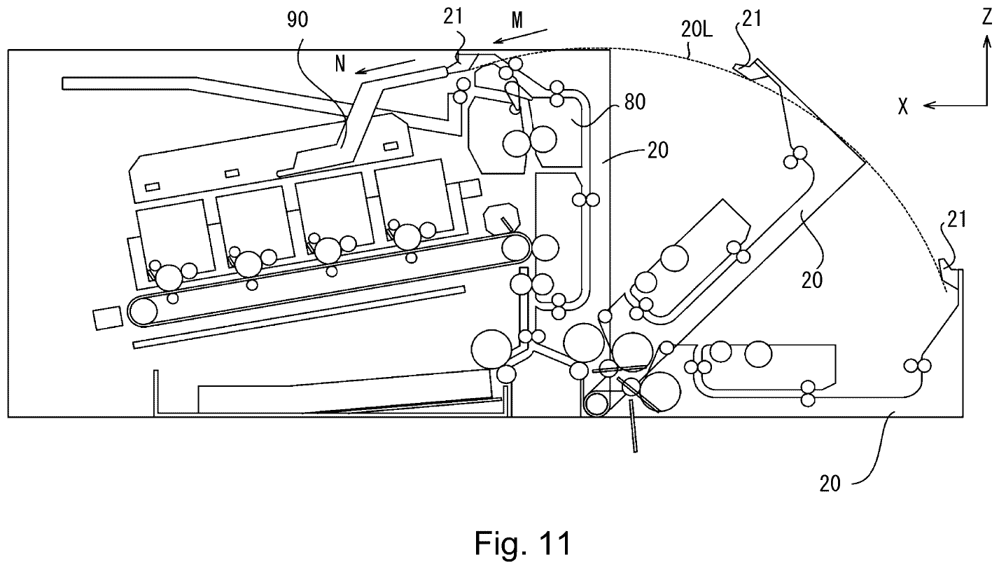

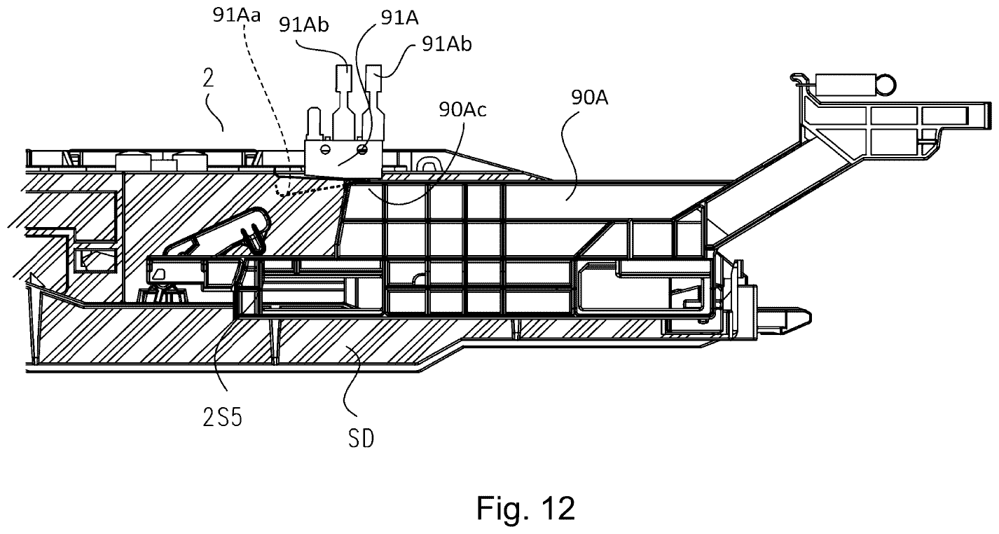

FIG. 3 is a schematic perspective view of the laser shutter 2S according to the first embodiment. As shown in FIG. 3, the laser shutter 2S is configured with a rotational shaft 2S1, a laser light shielding wall 2S2, a rotating boss 2S3, a restricting wall 2S4, and a positioning protrusion 2S5 (first engaging portion). FIG. 4 shows a bottom view of the laser shutter 2S which is placed in the scanner unit 2 (the scanner unit 2 is viewed from a bottom surface side of the main assembly 1A), and FIG. 5 shows a sectional view of it. First of all, a center line CL of the rotational shaft 2S1 of the laser shutter 2S is disposed below a rotational polygon mirror 210 in which the scanner unit 2 includes, and is disposed on a bisector E of laser lights 2K and 2C and laser lights 2M and 2Y which enter from an unshown semiconductor laser to the rotational polygon mirror 210. Incidentally, a direction of the rotational shaft 2S1 is defined as a Y direction, a direction of a rotational axis of the rotational polygon mirror 210 is defined as a Z direction, and a direction which is perpendicular to the Y direction and the Z direction is defined as an X direction.

Next, a position restriction of the laser shutter 2S with respect to the scanner unit 2 will be described. As shown in FIG. 4, a position of the rotational shaft 2S1 in the X direction is restricted by a first restricting wall 201 and a second restricting wall 202 which are provided with a casing 2a of the scanner unit 2. A position of the rotational shaft 2S1 in the Y direction is restricted, while the shielding wall 2S2 of the laser shutter 2S and the restricting wall 2S4 of the laser shutter 2S are sandwiched by the first restricting wall 201 and the second restricting wall 202 of the casing 2a of the scanner unit 2. A position of the rotational shaft 2S1 in the Z direction is restricted by a third restricting wall 203 and a fourth restricting wall 204 which are provided with the casing 2a of the scanner unit 2, and a fifth restricting wall 205 and a sixth restricting wall 206 which are disposed at positions which are opposed to the third restricting wall 203 and the fourth restricting wall 204, respectively, as shown in FIG. 5.

More specifically, a movement of a side portion of the rotational shaft 2S1, with which the shielding wall 2S2 is provided, is restricted in the Z direction by the third restricting wall 203 and the fifth restricting wall 205 which is provided to be opposed to the third restricting wall 203. A movement of a side portion of the rotational shaft 2S1, with which the restricting wall 2S4 is provided, is restricted in the Z direction by the fourth restricting wall 204 and the sixth restricting wall 206 which is provided to be opposed to the fourth restricting wall 204. Further, each restricting portion is allowed for clearance so that the laser shutter 2S is able to operate smoothly.

Next, an operation of the laser shutter 2S according to the first embodiment will be described with reference to part (a) and part (b) of FIG. 6, and from part (a) through part (f) of FIG. 7. Part (a) of FIG. 6 is a view showing positional relationships of the laser shutter 2S, the laser lights 2K, 2C, 2M, and 2Y, and the rotational polygon mirror 210, while the door 20 is open. Part (b) of FIG. 6 is a view showing the positional relationships of the laser shutter 2S, the laser lights 2K, 2C, 2M, and 2Y, and the rotational polygon mirror 210, while the door 20 is closed.

First of all, as shown in part (a) of FIG. 6, while the door 20 is open, optical paths of the laser lights 2K, 2C, 2M, and 2Y from unshown semiconductor lasers to the rotational polygon mirror 210 are shielded by the shielding wall 2S2 so that the laser lights 2K, 2C, 2M, and 2Y do not leak out of the scanner unit 2. At this time, since an engaging portion 90e of the link 90 is spaced away from the positioning protrusion 2S5 of the laser shutter 2S, the laser shutter 2S rotates in a clockwise direction (hereinafter, referred to as a CW direction). And the positioning protrusion 2S5 contacts a portion 90b of the link 90, and the laser shutter 2S maintains an attitude which is shown in part (a) of FIG. 6. As shown in part (b) of FIG. 6, while the door 20 is closed, since the engaging portion 90e of the link 90 pushes the positioning protrusion 2S5 of the laser shutter 2S, the laser shutter 2S rotates in a counterclockwise direction (hereinafter, referred to as a CCW direction). Therefore, the optical paths of the lasers 2K, 2C, 2M, and 2Y from the unshown semiconductor laser to the rotational polygon mirror 210 are opened, and the electrostatic latent image which is described above is formed.

Next, a position of the link 90 and the attitude of the laser shutter 2S will be described. In part (a) and part (b) of FIG. 7, the door 20 is in the closing position, and the link 90 in the working position. At this time, the positioning protrusion 2S5 of the laser shutter 2S engages (contacts) the engaging portion 90e (third engaging portion) of the link 90, and the laser shutter 2S is in a state which is shown in part (b) of FIG. 6. Incidentally, a state, when the shielding wall 2S2 of the laser shutter 2S is not on the optical paths of the laser lights as shown in part (b) of FIG. 6 and does not shield the irradiated laser lights, is described as “open”. It is possible to irradiate the laser lights 2Y, 2M, 2C, and 2K onto each photosensitive drum 61 from the scanner unit 2.

When the door 20 is moved toward the opening position from a state which is shown in part (a) of FIG. 7, it becomes in a state which is shown in part (c) and part (d) of FIG. 7. The positioning protrusion 2S5 of the laser shutter 2S moves (goes down) along an inclined surface 90a of the link 90, and the laser shutter 2S rotates in the CW direction which is described above and maintains its attitude by contacting the portion 90b of the link 90. At this time, the laser shutter 2S is in a state which is shown in part (a) of FIG. 6. Incidentally, a state, when the shielding wall 2S2 of the laser shutter 2S is on the optical paths of the laser lights as shown in part (a) of FIG. 6 and shields the irradiated laser lights, is described as “closed”. In a state which is shown in part (e) and part (f) of FIG. 7, in which the door 20 has been furthermore moved to the opening position, the link 90 is regulated by an unshown frame of the main assembly 1A and in the standby position. The laser shutter 2S continues to contact the portion 90b of the link 90 and maintains its attitude.

Incidentally, the positioning protrusion 2S5 of the laser shutter 2S is located outside the casing 2a of the scanner unit 2 and is connected to the laser shielding wall 2S2 which is located inside the casing 2a of the scanner unit 2 through the rotational shaft 2S1 (see FIGS. 4 and 5). That is, the positioning protrusion 2S5, as an engaging portion which operates the laser shutter 2S, is rotatably supported on one side surface of outside of the casing 2a of the scanner unit 2 (see part (b) of FIG. 10). Incidentally, in from part (a) through part (f) of FIG. 7, the shielding wall 2S2, in fact, which is located inside the casing 2a of the scanner unit 2, is also shown with solid lines, for description.

Further, in a configuration according to the first embodiment, the laser shutter 2S is rotated to irradiate/block the laser lights, however, the operation of the laser shutter 2S is not limited to a rotatable type and it may irradiate/block the laser lights by moving in a linear direction. In this way, the laser lights 2Y, 2M, 2C, and 2K are securely shielded by the laser shutter 2S, even when the user opens the door in any states.

### Interlock Switch Operation

As shown in part (a) of FIG. 8, the interlock switch 91 is fixed to the unshown frame of the main assembly 1A via the switch holder 94. The interlock switch 91 is a switch which turns the high voltage power source on and off. A rotational member 92 which is rotatable is provided adjacent to the interlock switch 91 and is urged in one direction by an elastic member (torsion coil spring) 93. The rotational member 92 is rotatable by engaging with the link 90. Part (b) of FIG. 8 is a front view showing the interlock switch 91. When the door 20 which is unshown moves from the opening position to the closing position, the rotational member 92 is pushed in a direction of an arrow C in the figure and rotates in the CCW direction. As a result, an arm 91a of the interlock switch 91 is displaced from a dotted line position to a solid line position, and the switch turns on. A bundled cable 95 is laid via Faston terminals 91b from the interlock switch 91, and is connected to a board on which the high voltage power source which is unshown is mounted at a forefront in a direction of an arrow B.

Next, the position of the link 90 and an on/off state of the interlock switch 91 will be described. In part (a) and part (b) of FIG. 9, the door 20 is in the closing position and the link 90 is in the working position. At this time, an engaging portion 92a (second engaging portion) of the rotational member 92 engages with a protrusion 90c (fourth engaging portion) of the link 90, and the rotational member 92 is rotated in the CCW direction. At this point, the interlock switch 91 is on.

When the door 20 is moved toward the opening position from this state, it becomes in a state which is shown in part (c) and part (b) of FIG. 9, and the rotational member 92 rotates in the CW direction due to a force of the elastic member 93 and a movement of the protrusion 90c of the link 90. At this point, the interlock switch 91 turns off. In a state which is shown in part (e) and part (f) of FIG. 9, in which the door 20 has been furthermore moved to the opening position, the link 90 is regulated by the unshown frame of the main assembly 1A and in the standby position. The engaging portion 92a of the rotational member 92 continues to contact the protrusion 90c of the link 90, and the attitude of the rotational member 92 is maintained.

Incidentally, although the link 90 turns the interlock switch 91 on and off via the rotational member 92, the rotational member 92 only converts a transmission direction of a force from the link 90. In a broad sense, the rotational member 92 may also be an engaging portion which switches the on/off of the interlock switch 91.

### Positional Relationship of Laser Shutter and Interlock Switch

Part (a) of FIG. 10 is a perspective view showing each of engage portions of the laser shutter 2S, the interlock switch 91, and the link 90. The interlock switch 91 is placed near the scanner unit 2. The protrusion 90c of the link 90 and the engaging portion 90e of the link 90 are formed in a single part. The protrusion 90c engages with the interlock switch 91 via the rotational member 92. The engaging portion 90e engages with the positioning protrusion 2S5 of the laser shutter 2S.

The link 90 switches between the working position and the standby position by moving (sliding) between the positioning protrusion 2S5 of the laser shutter 2S and the interlock switch 91 in a direction of an arrow K (moving direction). Therefore, it is possible to accurately determine an order of the on/off of the interlock switch 91 and the operation of laser shutter 2S. The engaging portion 90e is disposed on one side as centered on the link 90 in a direction which is perpendicular to the direction of the arrow K (the direction of the rotational shaft 2S1 of the laser shutter 2S (hereinafter, referred to as a rotational axis direction)), and the protrusion 90c is disposed on the other side as centered on the link 90 in the direction which is perpendicular to the arrow K. A reaction force when turning on the interlock switch 91 and a reaction force which operates the laser shutter 2S act on both sides (90c, 90e) as centered on the link 90. Therefore, it is possible to suppress a torsion of the link 90 and a sliding operation of the link 90 becomes smooth.

Part (b) of FIG. 10 is a view of the scanner unit 2 when it is viewed in a direction of a side surface (a side surface direction of a side of the interlock switch 91) or in other words, when it is viewed in a direction of the rotational shaft 2S1 of the laser shutter 2S. The interlock switch 91 is located within an area of one side surface of the casing 2a of the scanner unit 2 (a diagonal line portion SD in part (b) of FIG. 10), in which the positioning protrusions 2S5 of the laser shutter 2S is disposed, when it is viewed in the rotational axis direction. However, it is not limited to this, and when a part of the engaging portion (including the rotational member 92) of the interlock switch 91 overlaps with one side surface of the scanner unit 2 (SD), the laser shutter 2S and the interlock switch 91 may be considered to be sufficiently close to each other. And the interlock switch 91 may be considered to be disposed in a position which is opposed to one side surface of the scanner unit 2 (see part (a) of FIG. 10).

Incidentally, in the first embodiment, as shown in FIG. 11, in an opening/closing locus 20L which is a locus traced by the protrusion member 21 during the opening/closing operation of the door 20, the protrusion member 21 of the door 20 is configured so as not to interfere with the fixing device 80 during the opening/closing of the door 20. Therefore, a size of the main assembly is prevented from becoming unnecessarily large. In the first embodiment, the door 20 is at a front side of the product, and the protrusion member 21 is located in a rear side of the product relative to the fixing device 80, when it is viewed from the door 20 side (opening/closing member side, front side). Therefore, it is possible to reduce a size of the link 90, and since the link 90 does not need to be an interlocking mechanism with a plurality of parts by way of the fixing device 80, etc., it is possible to improve an accuracy of operations without complicating the mechanism and to reduce costs.

Further, when the protrusion member 21 of the door 20 engages with the link 90, a pushing direction of the protrusion member 21 (a direction of an arrow M) (a tangential direction of the opening/closing locus 20L of the door 20) and a sliding direction of the link 90 (a direction of an arrow N) are substantially parallel. As a result, transmission efficiency of power is high, so it is possible to suppress a loss of moving amount and a torsion which are caused by a deformation of the link 90. Therefore, it is possible to accurately operate the interlock switch 91 and the laser shutter 2S from the door 20 even when the interlock switch 91 and the laser shutter 2S are placed in a position in the rear of the product.

As described above, the door 20 is one, and the link 90 engages with the door 20 at one point. Therefore, in a case that the door 20 is twisted, positional relationships between the link 90 and the engaging portions of the interlock switch 91/the laser shutter 2S do not change, so it is possible to securely transition states of both engaging portions. Further, since the link 90 is a slide member which is a substantially rod shape, it is less likely to cause torsion and deflection of the link 90 itself in response to a movement of a position due to the opening/closing of the door 20. Therefore, it is possible to securely switch on/off, even when the interlock switch 91 is disposed in an inner location inside the product.

As described above, according to the first embodiment, it is possible to operate the laser shutter and the interlock switch regardless of the torsion of the opening/closing cover, and to increase the degree of freedom of the placing position of the interlock switch without requiring the complicated mechanism.

### Second Embodiment

A second embodiment will be described. In the second embodiment, the same reference numeral as used in the first embodiment will be used for a similar configuration with the configuration which is described in the first embodiment which is described above. Further, a description may be omitted as for the similar configuration with the configuration which is described in the first embodiment.

### Interlock Switch and Link

In the second embodiment, an interlock switch 91A is directly engaged with a link 90A. In the first embodiment, the rotational member 92 is disposed next to the interlock switch 91 and a transmission direction of a force of the link 90 is converted, however, in the second embodiment, a force of the link 90A is transmitted directly to an arm 91Aa of the interlock switch 91A.

FIG. 12 is a side view of the scanner unit 2 according to the second embodiment. Compared to part (b) of FIG. 10 according to the first embodiment, a position of the interlock switch 91A is such that a moving direction of the arm 91Aa is in an up-down direction, as shown in FIG. 12. The unshown door 20 is in the closing position, and the link 90A is in the operation position. An engaging portion 90Ac between the link 90A and the interlock switch 91A pushes the arm 91Aa of the interlock switch 91A, and the interlock switch 91A is in a state of on. Incidentally, a Faston terminal of the interlock switch 91A is defined as 91Ab.

The interlock switch 91A partially overlaps an area of one side surface of the casing 2a of the scanner unit 2 (a diagonal line portion SD in FIG. 12), in which the positioning protrusions 2S5 of the laser shutter 2S is disposed. Even in such a case, the interlock switch 91A may be considered to be disposed in a position which is opposed to one side surface of the scanner unit 2 (area SD). The rotational member 92 according to the first embodiment is removed, and it is possible to securely operate the laser shutter 2S/the interlock switch 91A while a simpler mechanism is applied, so it is suitable.

As described above, according to the second embodiment, it is possible to operate the laser shutter and the interlock switch regardless of the torsion of the opening/closing cover, and to increase the degree of freedom of the placing position of the interlock switch without requiring the complicated mechanism.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-158651, filed on Sep. 12, 2024, which is hereby incorporated by reference herein in its entirety.

What is claimed is:

1. An image forming apparatus for forming an image on a recording material, the image forming apparatus comprising:
a scanner unit configured to emit a laser light depending on an image signal;
a photosensitive member on which a latent image is formed by the laser light emitted from the scanner unit;
a laser shutter including a first engaging portion and configured to shield the laser light;
an opening/closing member openable and closable to a main assembly of the image forming apparatus;
a link configured to operate in interrelation with an opening/closing operation of the opening/closing member; and
an interlock switch including a second engaging portion and configured to turn on or turn off a high voltage power source,
wherein the link includes a third engaging portion engaged with the first engaging portion of the laser shutter and a fourth engaging portion engaged with the second engaging portion of the interlock switch,
wherein the first engaging portion of the laser shutter is disposed on one side surface of a casing of the scanner unit, and
wherein the second engaging portion of the interlock switch is disposed at a position opposing the one side surface of the casing of the scanner unit.

2. The image forming apparatus according to claim 1, the opening/closing member is provided in the main assembly by one and is engaged with the link in one portion.

3. The image forming apparatus according to claim 1, further comprising:
a developing member configured to develop the latent image formed on the photosensitive member and to form a developer image;
a transfer member configured to transfer the developer image onto the recording material; and
a fixing device configured to fix the developer image, on the recording material, which is unfixed,
wherein the opening/closing member includes a projecting portion engaged with the link, and
wherein as viewed from a side of the opening/closing member, the projecting portion is on a back side of the fixing device when the opening/closing member is in a closing position.

4. The image forming apparatus according to claim 3, wherein the link is capable of a slidable movement between an operation position where the opening/closing member is in the closing position and a standby position where the opening/closing member is in an opening position, and
wherein a moving direction of the slidable movement is parallel to a moving direction of the opening/closing member when the projecting portion of the opening/closing member and the link are engaged with each other.

5. The image forming apparatus according to claim 4, wherein the link slidably moves between the laser shutter and the interlock switch.

6. The image forming apparatus according to claim 5, wherein the third engaging portion is disposed on one side of the link with respect to a direction of a rotational shaft of the laser shutter, and
wherein the fourth engaging portion is disposed on the other side of the link with respect to the direction of the rotational shaft of the laser shutter.

7. The image forming apparatus according to claim 1, wherein the third engaging portion and the fourth engaging portion are formed by one component.
